(19) United States
(12) Patent Application Publication
(10) Pub. No.: US 2017/0057260 A1
(43) Pub. Date: Mar. 2, 2017

(54) INKJET HEAD APPARATUS AND PRINTER INCLUDING THE SAME

(71) Applicant: Roland DG Corporation, Hamamatsu-shi (JP)

(72) Inventor: Naoki UEDA, Hamamatsu-shi (JP)

(21) Appl. No.: 15/248,231

(22) Filed: Aug. 26, 2016

(30) Foreign Application Priority Data
Aug. 28, 2015 (JP) 2015-169131

(51) Int. Cl. B41J 25/00; B41J 2/01

(52) U.S. Cl. CPC B41J 25/001; B41J 2/01

(57) ABSTRACT

An inkjet head apparatus includes a carriage including base plates, a head plate supported by the base plates, recording heads each attached to an associated one of openings of the head plate, a pivot between the base plate and the head plate so that the head plate is rotatably supported by the base plate, and an adjusting screw to adjust the positions of the recording heads with respect to the base plates. At least a portion of the pivot and at least a portion of the adjusting screw are disposed rearward of the front ends of the openings and forward of the rear ends of the openings.

### CROSS REFERENCE TO RELATED APPLICATIONS

The present application claims priority to Japanese Patent Application No. 2015-169131 filed on Aug. 28, 2015, which is incorporated by reference herein in its entirety.

### BACKGROUND OF THE INVENTION

1. Field of the Invention

The present invention relates to inkjet head apparatuses to eject ink and printers including such inkjet head apparatuses.

2. Description of the Related Art

A known printer includes a carriage that moves in a main scanning direction and an inkjet head apparatus including a plurality of recording heads provided on the carriage. The recording heads are aligned in the main scanning direction. The recording heads each include a plurality of nozzles aligned in a sub-scanning direction perpendicular to the main scanning direction. This printer is configured so that the recording heads eject ink onto a recording medium while the carriage moves in the main scanning direction, thus performing printing on the recording medium.

For example, suppose that the direction in which the nozzles of the recording heads are aligned (which will hereinafter be referred to as a “nozzle alignment direction”) is inclined with respect to the sub-scanning direction. In such a case, printing accuracy degrades. To solve such a problem, JP 2007-276288 A discloses a position adjuster that adjusts the positions of recording heads with respect to a carriage.

The position adjuster disclosed in JP 2007-276288 A includes a head plate to which a plurality of recording heads are attached and a sub-carriage supporting the head plate. The sub-carriage is provided at its left front end portion with a pivot shaft (which will hereinafter be referred to as a “pivot”). The head plate is provided at its left front end portion with a cut-out. The pivot is engaged with the cut-out. The sub-carriage is provided at its right front end portion with a head adjusting screw. The position adjuster is configured so that rotation of the head adjusting screw causes the head plate to rotate around the pivot, thus changing the position of the head plate with respect to the sub-carriage. Consequently, rotating the head adjusting screw enables the positions of the plurality of recording heads relative to the carriage to be adjusted.

Unfortunately, because the pivot of the position adjuster is provided in the left front end portion of the sub-carriage, the amount of positional change of each recording head relative to the amount of movement of the head adjusting screw may vary significantly depending on the position of each recording head. In other words, if the head adjusting screw is moved by the same amount, the position of each recording head may change significantly in some cases and may change slightly in other cases. Thus, the positions of the recording heads do not change to desirable positions in response to movement of the head adjusting screw, making it difficult to carry out the position adjusting operation satisfactorily.

### SUMMARY OF THE INVENTION

Accordingly, preferred embodiments of the present invention provide an inkjet head apparatus that enables positions of a plurality of recording heads relative to a carriage to be adjusted without difficulty.

An inkjet head apparatus according to a preferred embodiment of the present invention includes a carriage, a head plate, a plurality of recording heads, a pivot, and an adjusting screw. The carriage includes a first base plate and a second base plate. The head plate is provided with a plurality of openings at least some of which are located along a first direction. The head plate is supported by the first base plate and the second base plate. The recording heads each include a plurality of nozzles at least some of which are located along a second direction perpendicular or substantially perpendicular to the first direction. Each of the recording heads is attached to an associated one of the openings of the head plate. The pivot is disposed between the first base plate and the head plate so that the head plate is rotatably supported by the first base plate. The adjusting screw is able to rotate the head plate around the pivot and relative to the first and second base plates, thus adjusting positions of the recording heads with respect to the first and second base plates. The inkjet head apparatus includes a first end and a second end. The first end is one end of the inkjet head apparatus in the second direction. The second end is the other end of the inkjet head apparatus in the second direction. At least a portion of the pivot and at least a portion of the adjusting screw are disposed closer to the second end than portions of the openings closest to the first end, and are disposed closer to the first end than portions of the openings closest to the second end.

Moving the adjusting screw of the inkjet head apparatus according to this preferred embodiment rotates the head plate around the pivot and changes the position of the head plate with respect to the first base plate and the second base plate, thus adjusting the positions of the recording heads with respect to the first base plate and the second base plate. At least a portion of the pivot and at least a portion of the adjusting screw are disposed closer to the second end than the portions of the openings closest to the first end, and are disposed closer to the first end than the portions of the openings closest to the second end. This allows the amount of positional change of each recording head to be proportionate or substantially proportionate to the amount of movement of the adjusting screw irrespective of the position of each recording head. Consequently, the positions of the recording heads are changed to desirable positions in response to movement of the adjusting screw, resulting in facilitation of the position adjusting operation.

Various preferred embodiments of the present invention provide an inkjet head apparatus that enables the positions of a plurality of recording heads relative to a carriage to be adjusted without difficulty.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a printer according to a preferred embodiment of the present invention.

FIG. 2 is a perspective view of an inkjet head apparatus according to a preferred embodiment of the present invention.

FIG. 3 is a plan view of the inkjet head apparatus, with its recording heads removed therefrom.

FIG. 4 is a bottom view of the inkjet head apparatus.

FIG. 5 is a schematic diagram illustrating how a head plate rotates.

FIG. 6 is a schematic diagram illustrating the relationship between the amount of movement of an adjusting screw and the amount of positional change of a recording head.

### DETAILED DESCRIPTION OF THE PREFERRED EMBODIMENTS

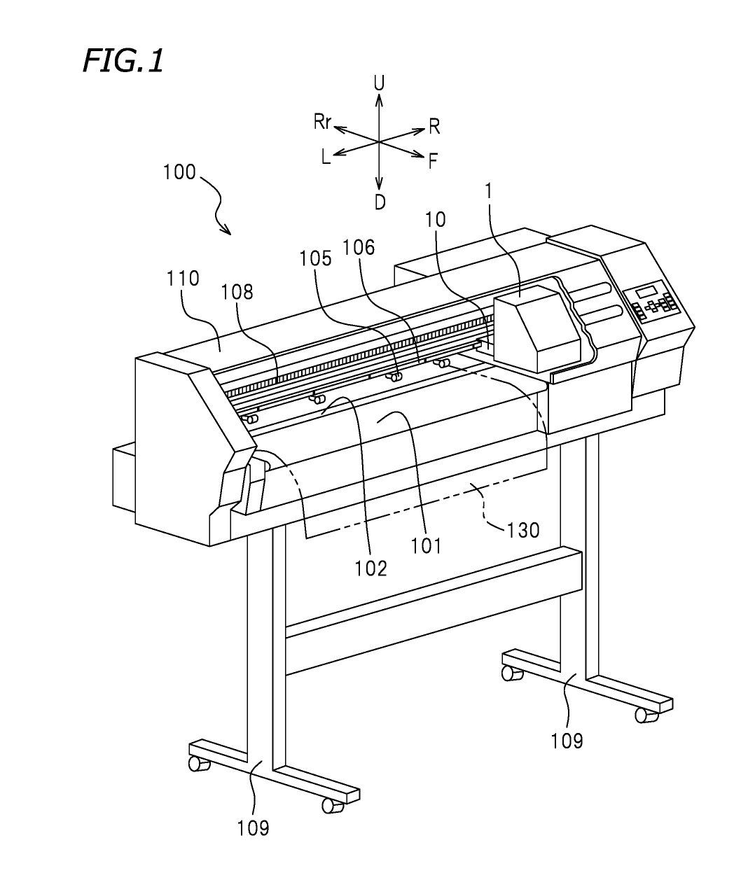

Preferred embodiments of the present invention will be described below. A printer 100 according to a preferred embodiment of the present invention preferably is an inkjet printer. As illustrated in FIG. 1, the printer 100 preferably includes a platen 101 to support a recording paper 130, a feed roller 102 provided on the platen 101, pinch rollers 105 provided above the feed roller 102, a rail 106 disposed above the platen 101, an inkjet head apparatus 1 in slidable engagement with the rail 106, and a belt 108 fixed to the inkjet head apparatus 1. The platen 101, the feed roller 102, the pinch rollers 105, the rail 106, the inkjet head apparatus 1, and the belt 108 are disposed inside a case 110. The case 110 is supported by legs 109.

As used herein, the term “forward” refers to the direction toward a user in front of the printer 100, and the term “rearward” refers to the direction away from the user in front of the printer 100. As used herein, the terms “right”, “left”, “up”, and “down” respectively refer to right, left, up, and down when the printer 100 is viewed from the front. The reference signs “F”, “Rr”, “R”, “L”, “U”, and “D” in the drawings respectively represent front, rear, right, left, up, and down. These directions are defined merely for the sake of convenience and do not limit in any way how the printer 100 may be installed or how the invention may be practiced.

The rail 106 extends in the right-left direction. The rail 106 supports the inkjet head apparatus 1 so that the inkjet head apparatus 1 is slidable along the rail 106. As used herein, the term “main scanning direction” refers to the direction in which the rail 106 extends, i.e., the right-left direction. As used herein, the term “sub-scanning direction” refers to the front-rear direction. In other words, the sub-scanning direction is perpendicular or substantially perpendicular to the main scanning direction and the up-down direction.

Although not illustrated, a driving pulley and a driven pulley are respectively disposed in right and left end portions of the inner space of the case 110. The driving pulley is actuated by a motor. The belt 108 is wound around the driving pulley and the driven pulley and thus circulates around these pulleys in accordance with rotation of the driving pulley. This moves the inkjet head apparatus 1 in the main scanning direction. A combination of the driving pulley, the driven pulley, and the belt 108 is an example of a driver that is connected to the inkjet head apparatus 1 and is operative to move the inkjet head apparatus 1 along the rail 106. The driver is not limited to any particular configuration but may have any other configuration.

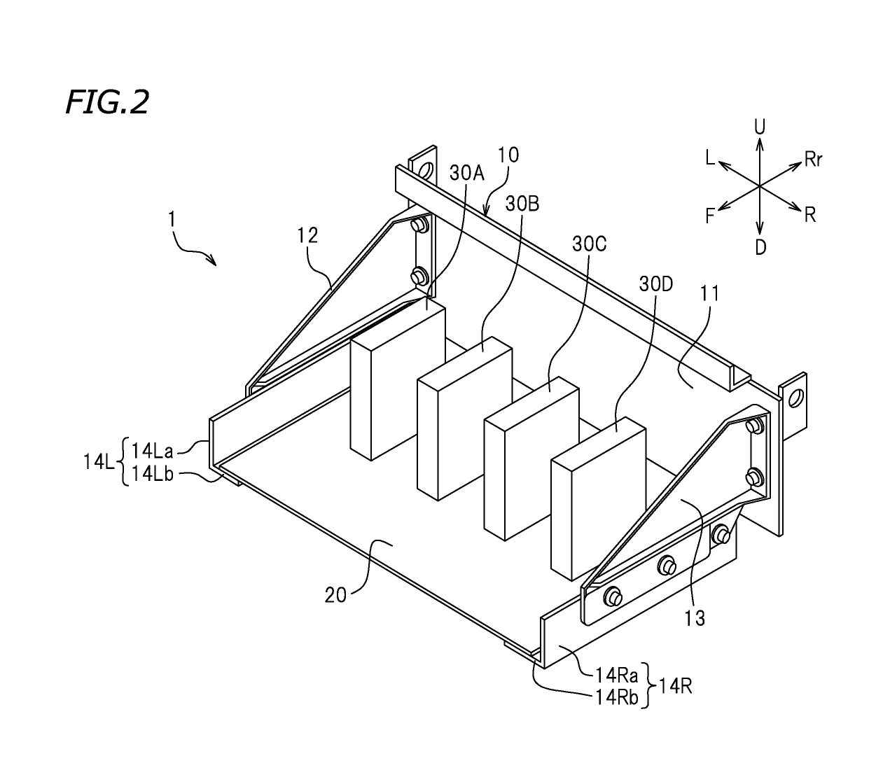

The inkjet head apparatus 1 will be described below. The inkjet head apparatus 1 is disposed above the platen 101. As illustrated in FIG. 2, the inkjet head apparatus 1 preferably includes a carriage 10, a head plate 20, and a plurality of recording heads 30A to 30D. As illustrated in FIG. 1, the carriage 10 is in slidable engagement with the rail 106. In FIG. 2, a portion of the carriage 10 in engagement with the rail 106 is not illustrated. The inkjet head apparatus 1 is structured such that the recording heads 30A to 30D eject ink onto the recording paper 130 while the carriage 10 moves along the rail 106 in the main scanning direction. Although the recording paper 130 is used as an example of a recording medium, any recording medium other than the recording paper 130 may be used.

As illustrated in FIG. 2, the carriage 10 preferably includes a rear plate 11 extending vertically, a left plate 12 fixed to the left end of the rear plate 11, and a right plate 13 fixed to the right end of the rear plate 11. The left plate 12 and the right plate 13 each extend forward from the rear plate 11. The carriage 10 preferably further includes a left base plate 14L fixed to the left plate 12 and a right base plate 14R fixed to the right plate 13. The left base plate 14L and the right base plate 14R each extend in the front-rear direction. The left base plate 14L and the right base plate 14R each preferably have an L-shaped cross section. The left base plate 14L preferably includes a vertical portion 14La extending vertically and a horizontal portion 14Lb extending horizontally. The right base plate 14R preferably includes a vertical portion 14Ra extending vertically and a horizontal portion 1 4Rb extending horizontally. In this preferred embodiment, the base plates 14L and 14R are preferably made of sheet metal, for example. The base plates 14L and 14R, however, are not limited to any particular shape or material. In this preferred embodiment, the rear plate 11, the left plate 12, the right plate 13, the left base plate 14L, and the right base plate 14R are separate components and are assembled into the carriage 10. Alternatively, some or all of the rear plate 11, the left plate 12, the right plate 13, the left base plate 14L, and the right base plate 14R may be integral with each other. In other words, the carriage 10 may be assembled from a plurality of components or may be provided by a single component.

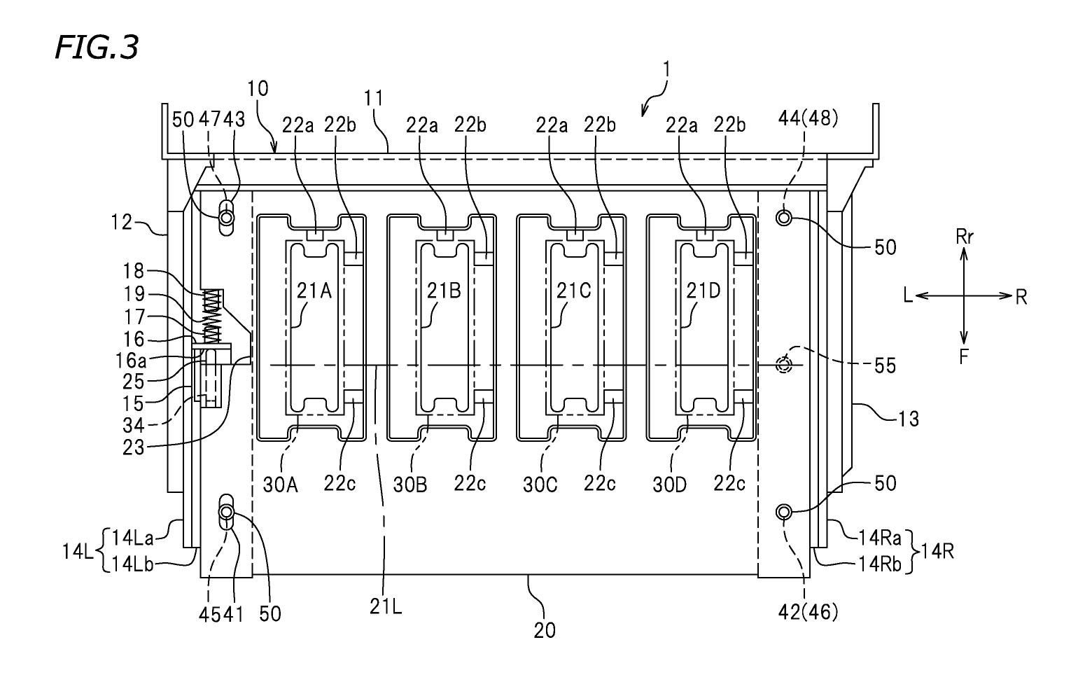

As illustrated in FIG. 3, the head plate 20 is supported by the base plates 14L and 14R. The head plate 20 is provided with a plurality of openings 21A, 21B, 21C, and 21D aligned in the main scanning direction. The recording heads 30A to 30D are respectively attached to the openings 21A to 21D. As used herein, the expression “attached to the openings 21A to 21D” refers to not only being fitted into the openings 21A to 21D but also being disposed so as to be partially located above the openings 21A to 21D, for example.

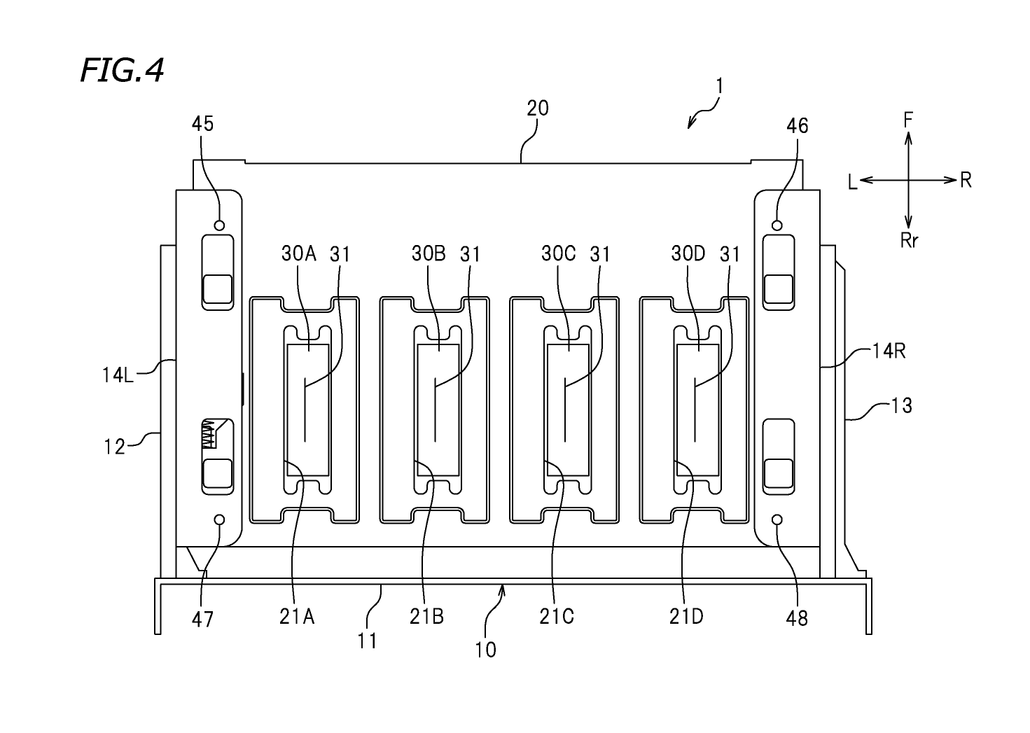

As illustrated in FIG. 4, the recording heads 30A to 30D preferably each include a plurality of nozzles 31 at least some of which are located along the sub-scanning direction. The nozzles 31 are very small and thus indicated by straight lines in FIG. 4. The nozzles 31 of the recording heads 30A to 30D are respectively located inward of the openings 21A to 21D when viewed from below.

As illustrated in FIG. 3, the head plate 20 is provided with first abutments 22a each located behind an associated one of the openings 21A to 21D. The rear portions of the recording heads 30A to 30D are pressed against the first abutments 22a. The head plate 20 is further provided with second abutments 22b and third abutments 22c each located rightward of an associated one of the openings 21A to 21D. The right portions of the recording heads 30A to 30D are pressed against the second abutments 22b and the third abutments 22c. The third abutments 22c are disposed in front of the second abutments 22b. The second abutments 22b are pressed against the right rear portions of the recording heads 30A to 30D. The third abutments 22c are pressed against the right front portions of the recording heads 30A to 30D. The first to third abutments 22a to 22c position the recording heads 30A to 30D with respect to the head plate 20. The recording heads 30A to 30D are respectively attached to the openings 21A to 21D and are pressed against the associated first to third abutments 22a to 22c, thus accurately disposing the recording heads 30A to 30D at predetermined positions on the head plate 20. Although the number of abutments for each recording head is preferably three in this preferred embodiment, for example, any number of abutments may be provided for each recording head. Each abutment maybe located at any suitable position. The first to third abutments 22a to 22c are not essential but optional.

Each of the openings 21A to 21D is provided so that its front-rear length is longer than its right-left length. In this preferred embodiment, the openings 21A to 21D preferably have the same or substantially the same shape and size. Alternatively, the openings 21A to 21D may have different shapes. The openings 21A to 21D are not limited to any particular size. For example, any one of the openings 21A to 21D may be larger than any other one of the openings 21A to 21D. The openings 21A to 21D are not limited to any particular positions. In this preferred embodiment, the openings 21A to 21D are aligned in a row perpendicular or substantially perpendicular to the sub-scanning direction. More specifically, the front ends of the openings 21A to 21D are aligned in a plane perpendicular or substantially perpendicular to the sub-scanning direction, and the rear ends of the openings 21A to 21D are aligned in a plane perpendicular or substantially perpendicular to the sub-scanning direction. The openings 21A to 21D, however, do not necessarily have to be aligned in a row perpendicular or substantially perpendicular to the sub-scanning direction. In one example, the front end of any one of the openings 21A to 21D may be located rearward of the front end of any other one of the openings 21A to 21D. In another example, the rear end of any one of the openings 21A to 21D may be located forward of the rear end of any other one of the openings 21A to 21D.

The recording heads 30A to 30D are arranged similarly to the openings 21A to 21D. In this preferred embodiment, the recording heads 30A to 30D have the same or substantially the same shape and size. Alternatively, the recording heads 30A to 30D may have different shapes and sizes. In this preferred embodiment, the recording heads 30A to 30D are aligned in a row perpendicular or substantially perpendicular to the sub-scanning direction. The recording heads 30A to 30D, however, do not necessarily have to be aligned in a row perpendicular or substantially perpendicular to the sub-scanning direction.

As illustrated in FIG. 3, the right base plate 14R is provided with a pivot 55. The pivot 55 supports the head plate 20 so that the head plate 20 is rotatable around the pivot 55. The pivot 55 extends upward from the horizontal portion 14Rb of the right base plate 14R and is disposed between the right base plate 14R and the head plate 20. Rotating the head plate 20 around the pivot 55 changes the relative positions of the head plate 20 and the right base plate 14R. More specifically, rotating the head plate 20 around the pivot 55 changes the angle between the main scanning direction and the direction in which the openings 21A to 21D of the head plate 20 are aligned. The direction in which the openings 21A to 21D are aligned is indicated by the alternate long and short dash lines in FIG. 3 and will hereinafter be referred to as an alignment direction 21L. The alignment direction 21L of the openings 21A to 21D corresponds to the alignment direction of the recording heads 30A to 30D. The pivot 55 may be integral with one of the right base plate 14R and the head plate 20 or may be separate from both of the right base plate 14R and the head plate 20. In this preferred embodiment, the pivot 55 is integral with the right base plate 14R.

The pivot 55 is disposed rearward of the foremost portions of the openings 21A to 21D and forward of the rearmost portions of the openings 21A to 21D. In this preferred embodiment, the openings 21A to 21D are aligned in a row perpendicular or substantially perpendicular to the sub-scanning direction as mentioned above. Thus, the pivot 55 is disposed rearward of the front ends of the openings 21A to 21D and forward of the rear ends of the openings 21A to 21D. The pivot 55 is disposed rearward of the front ends of the recording heads 30A to 30D and forward of the rear ends of the recording heads 30A to 30D.

The inkjet head apparatus 1 preferably includes a first end, a second end, a third end, and a fourth end. The first end is one end of the inkjet head apparatus 1 in the sub-scanning direction (e.g., the front end of the inkjet head apparatus 1 in this preferred embodiment). The second end is the other end of the inkjet head apparatus 1 in the sub-scanning direction (e.g., the rear end of the inkjet head apparatus 1 in this preferred embodiment). The third end is one end of the inkjet head apparatus 1 in the main scanning direction (e.g., the right end of the inkjet head apparatus 1 in this preferred embodiment). The fourth end is the other end of the inkjet head apparatus 1 in the main scanning direction (e.g., the left end of the inkjet head apparatus 1 in this preferred embodiment). The pivot 55 is disposed closer to the third end than one of the openings 21A to 21D that is closest to the third end, i.e., the opening 21D. In this preferred embodiment, the pivot 55 is disposed rightward of the rightmost one of the openings 21A to 21D, i.e., the opening 21D. In other words, the pivot 55 is disposed rightward of all of the openings 21A to 21D. The location of the pivot 55, however, is not limited to the above-described location.

The head plate 20 is provided at its left end portion with a recess 23 recessed rightward. A tapped hole 34 is provided in front of the recess 23. The tapped hole 34 extends in the front-rear direction. An adjusting screw 25 is inserted into the tapped hole 34. The inner surface of the tapped hole 34 is threaded spirally. The outer surface of the adjusting screw 25 is threaded spirally. The spiral thread on the outer surface of the adjusting screw 25 is engaged with the spiral thread on the inner surface of the tapped hole 34. An extremity of the adjusting screw 25 (i.e., the rear end of the adjusting screw 25) protrudes from the tapped hole 34. A root of the adjusting screw 25 (i.e., the front end of the adjusting screw 25) is provided with a groove in the shape of a plus sign “+” or a minus sign “−” (not illustrated). A screwdriver (not illustrated) is to be brought into engagement with this groove. This groove is an example of an engagement portion to be brought into engagement with a tool that is used to rotate the adjusting screw 25. The tool is not limited to a screwdriver. The engagement portion is not limited to the groove but may be any other suitable portion, element, or component that is to be brought into engagement with the tool.

An abutment 15 is fixed to the left base plate 14L. The abutment 15 may be fixed to the horizontal portion 14Lb or the vertical portion 14La of the left base plate 14L. The abutment 15 may be separate from or integral with the left base plate 14L. At least a portion of the abutment 15 is disposed inward of the recess 23 of the head plate 20 when viewed from above. The abutment 15 preferably includes an abutment plate 16 located behind the adjusting screw 25. The adjusting screw 25 protrudes from the tapped hole 34 toward the abutment plate 16. The front surface of the abutment plate 16 defines and functions as an abutment surface 16a against which the adjusting screw 25 abuts. A first shaft 17 extends from the rear surface of the abutment plate 16 opposite to the abutment surface 16a.

A portion of the head plate 20 facing the first shaft 17 is provided with a second shaft 18 extending toward the first shaft 17. The second shaft 18 is disposed behind the first shaft 17. The first shaft 17 and the second shaft 18 each extend in the front-rear direction.

A coil spring 19 is attached to the first shaft 17 and the second shaft 18. The coil spring 19 connects the first shaft 17 and the second shaft 18 to each other. The coil spring 19 is compressed to a length shorter than its natural length and thus functions as a compression spring. The coil spring 19 urges the first shaft 17 and the second shaft 18 away from each other. Because the head plate 20 is rotatable around the pivot 55, the coil spring 19 urges the head plate 20 clockwise when viewed from above. The clockwise direction corresponds to the direction in which the adjusting screw 25 approaches the abutment plate 16. Thus, the coil spring 19 urges the head plate 20 so that the adjusting screw 25, which is inserted into the tapped hole 34, abuts against the abutment 15. The coil spring 19 causes the adjusting screw 25 to constantly abut against the abutment 15. The coil spring 19 defines and functions as an example of a spring to urge the head plate 20 so that the adjusting screw 25 abuts against the abutment 15. This spring, however, is not limited to the coil spring 19. Any other suitable spring, such as a torsion spring, may be used. The first shaft 17 and the second shaft 18 are optional components. The coil spring 19 may be attached to any other portion or component of the left base plate 14L and any other portion or component of the head plate 20. This eliminates the need for the first shaft 17 and the second shaft 18.

The adjusting screw 25 is disposed to the left of the openings 21A to 21D and the recording heads 30A to 30D. The openings 21A to 21D and the recording heads 30A to 30D are disposed between the pivot 55 and the adjusting screw 25 in the main scanning direction. The pivot 55 and the adjusting screw 25 are disposed to overlap with portions of the openings 21A to 21D and portions of the recording heads 30A to 30D when viewed in the main scanning direction. In this preferred embodiment, a portion of the adjusting screw 25 is aligned with the pivot 55 in a plane perpendicular or substantially perpendicular to the sub-scanning direction. In other words, a portion of the adjusting screw 25 is disposed rearward of the front end of the pivot 55 and forward of the rear end of the pivot 55. The adjusting screw 25, however, is not limited to this location. In one example, the adjusting screw 25 may be disposed entirely forward of the front end of the pivot 55. In another example, the adjusting screw 25 may be disposed entirely rearward of the rear end of the pivot 55.

At least a portion of the adjusting screw 25 is disposed closer to the second end than portions of the openings 21A to 21D closest to the first end, and is disposed closer to the first end than portions of the openings 21A to 21D closest to the second end. As mentioned above, the openings 21A to 21D according to this preferred embodiment are aligned in a row perpendicular or substantially perpendicular to the sub-scanning direction. Thus, at least a portion of the adjusting screw 25 is disposed rearward of the front ends of the openings 21A to 21D and forward of the rear ends of the openings 21A to 21D. At least a portion of the adjusting screw 25 is disposed closer to the second end than portions of the recording heads 30A to 30D closest to the first end, and is disposed closer to the first end than portions of the recording heads 30A to 30D closest to the second end. Thus, at least a portion of the adjusting screw 25 is disposed rearward of the front ends of the recording heads 30A to 30D and forward of the rear ends of the recording heads 30A to 30D.

The head plate 20 is preferably provided with first to fourth holes 41 to 44. The first to fourth holes 41 to 44 are provided in the four corners of the head plate 20. More specifically, the first hole 41 is located closer to the fourth end (e.g., the left end of the inkjet head apparatus 1 in this preferred embodiment) than the end of one of the openings 21A to 21D closest to the fourth end, and is located closer to the first end (e.g., the front end of the inkjet head apparatus 1 in this preferred embodiment) than the ends of the openings 21A to 21D closest to the first end. The second hole 42 is located closer to the third end (e.g., the right end of the inkjet head apparatus 1 in this preferred embodiment) than the end of one of the openings 21A to 21D closest to the third end, and is located closer to the first end (e.g., the front end of the inkjet head apparatus 1 in this preferred embodiment) than the ends of the openings 21A to 21D closest to the first end. The third hole 43 is located closer to the fourth end (e.g., the left end of the inkjet head apparatus 1 in this preferred embodiment) than the end of one of the openings 21A to 21D closest to the fourth end, and is located closer to the second end (e.g., the rear end of the inkjet head apparatus 1 in this preferred embodiment) than the ends of the openings 21A to 21D closest to the second end. The fourth hole 44 is located closer to the third end (e.g., the right end of the inkjet head apparatus 1 in this preferred embodiment) than the end of one of the openings 21A to 21D closest to the third end, and is located closer to the second end (e.g., the rear end of the inkjet head apparatus 1 in this preferred embodiment) than the ends of the openings 21A to 21D closest to the second end. As mentioned above, the openings 21A to 21D according to this preferred embodiment are preferably aligned in a row perpendicular or substantially perpendicular to the sub-scanning direction. Thus, the first hole 41 is located leftward of the leftmost one of the openings 21A to 21D, i.e., the opening 21A, and forward of the front ends of the openings 21A to 21D. The second hole 42 is located rightward of the rightmost one of the openings 21A to 21D, i.e., the opening 21D, and forward of the front ends of the openings 21A to 21D. The third hole 43 is located leftward of the leftmost one of the openings 21A to 21D, i.e., the opening 21A, and rearward of the rear ends of the openings 21A to 21D. The fourth hole 44 is located rightward of the rightmost one of the openings 21A to 21D, i.e., the opening 21D, and rearward of the rear ends of the openings 21A to 21D. Each of the first hole 41 and the third hole 43 is an elongated hole extending in the front-rear direction. Each of the second hole 42 and the fourth hole 44 is a circular hole. The first to fourth holes 41 to 44, however, are not limited to these shapes. For example, any two of the first to fourth holes 41 to 44 may be elongated holes, and the other two of the first to fourth holes 41 to 44 may be circular holes.

The left base plate 14L is provided with a fifth hole 45 and a seventh hole 47. The right base plate 14R is provided with a sixth hole 46 and an eighth hole 48. The fifth hole 45 is associated with the first hole 41 of the head plate 20. The sixth hole 46 is associated with the second hole 42 of the head plate 20. The seventh hole 47 is associated with the third hole 43 of the head plate 20. The eighth hole 48 is associated with the fourth hole 44 of the head plate 20. The fifth hole 45 is provided in the front end portion of the left base plate 14L. The seventh hole 47 is provided in the rear end portion of the left base plate 14L. The sixth hole 46 is provided in the front end portion of the right base plate 14R. The eighth hole 48 is provided in the rear end portion of the right base plate 14R. The fifth to eighth holes 45 to 48 preferably are circular or substantially circular holes. Of the first to eighth holes 41 to 48, the first hole 41 and the third hole 43 are preferably elongated holes in this preferred embodiment. The elongated holes are not limited to the first hole 41 and the third hole 43. For example, any two of the first to eighth holes 41 to 48 that do not overlap with each other may be elongated holes.

A non-limiting example of a method for adjusting the positions of the recording heads 30A to 30D will be described below. The positions of the recording heads 30A to 30D are adjusted by rotating the adjusting screw 25. In this preferred embodiment, clockwise rotation of the adjusting screw 25 increases the amount of protrusion of the adjusting screw 25 from the tapped hole 34, thus rotating the head plate 20 around the pivot 55 counterclockwise when viewed from above. In contrast, counterclockwise rotation of the adjusting screw 25 reduces the amount of protrusion of the adjusting screw 25 from the tapped hole 34, thus rotating the head plate 20 around the pivot 55 clockwise when viewed from above. Rotating the adjusting screw 25 clockwise and/or counterclockwise adjusts the inclination of the alignment direction 21L of the recording heads 30A to 30D with respect to the main scanning direction. During rotation of the adjusting screw 25, the coil spring 19 urges the head plate 20 and causes the adjusting screw 25 to constantly abut against the abutment 15, thus preventing unstable positional change of the head plate 20. This consequently enables reliable adjustment of the positions of the recording heads 30A to 30D.

The head plate 20 is positioned with respect to the right base plate 14R, and then machine screws 50 are each inserted into a pair of the first hole 41 and the fifth hole 45, a pair of the second hole 42 and the sixth hole 46, a pair of the third hole 43 and the seventh hole 47, and a pair of the fourth hole 44 and the eighth hole 48. This fastens the head plate 20 to the base plates 14L and 14R. As a result, the recording heads 30A to 30D, which are fixed to the head plate 20, are secured to the carriage 10.

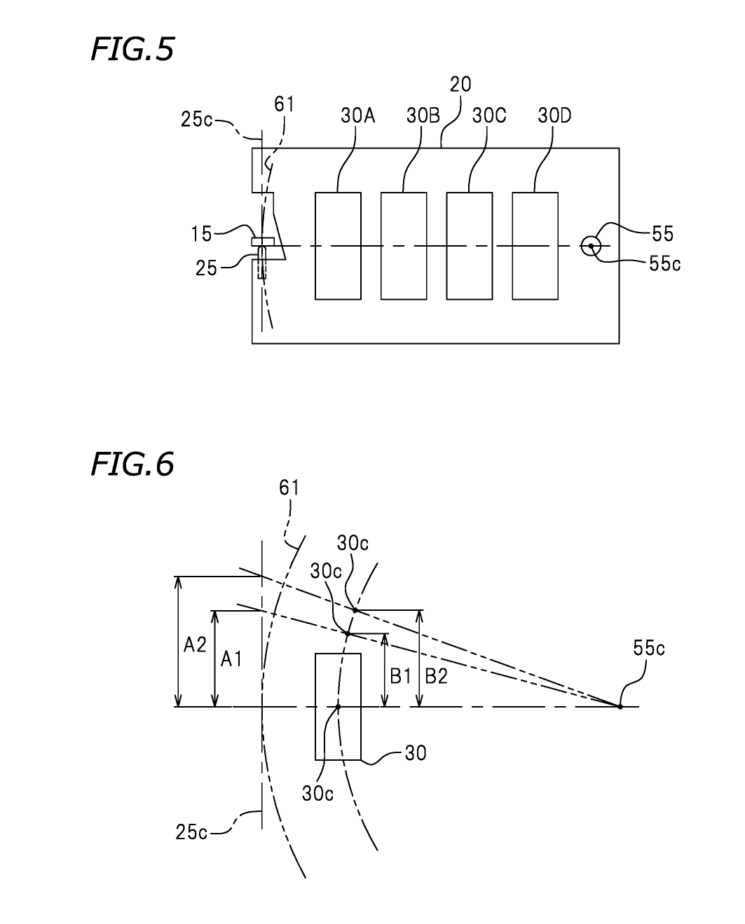

As illustrated in FIG. 5, the head plate 20 rotates around a center 55c of the pivot 55 and thus moves along an arc 61. An axis 25c of the adjusting screw 25 is tangent to the arc 61. In this preferred embodiment, the pivot 55 and the adjusting screw 25 are disposed rearward of the front ends of the openings 21A to 21D and forward of the rear ends of the openings 21A to 21D. Thus, the amount of positional change of the recording heads 30A to 30D relative to the amount of movement of the adjusting screw 25 does not vary significantly depending on the positions of the recording heads 30A to 30D. For example, suppose that as illustrated in FIG. 6, any selected one of the recording heads 30A to 30D is a “recording head 30”, A1 and A2 each represent the amount of movement of the adjusting screw 25, B1 represents the amount of positional change of a center 30c of the recording head 30 obtained when the adjusting screw 25 is moved by the amount A1, and B2 represents the amount of positional change of the center 30c of the recording head 30 obtained when the adjusting screw 25 is moved by the amount A2. In this case, the ratio of B1 to A1 (i.e., B1/A1) and the ratio of B2 to A2 (i.e., B2/A2) do not differ significantly. Thus, this preferred embodiment changes the positions of the recording heads 30A to 30D to desirable positions in response to movement of the adjusting screw 25. Consequently, the position adjusting operation is performed more easily than before.

The openings 21A to 21D according to this preferred embodiment are preferably aligned in a row perpendicular or substantially perpendicular to the sub-scanning direction. Thus, the positional changes of the recording heads 30A to 30D responsive to movement of the adjusting screw 25 are made more uniform than when the openings 21A to 21D are not aligned in a row perpendicular or substantially perpendicular to the sub-scanning direction. This changes the positions of the recording heads 30A to 30D to more desirable positions in response to movement of the adjusting screw 25. Consequently, the position adjusting operation is facilitated.

Although the pivot 55 may be provided between two adjacent ones of the openings 21A to 21D, the pivot 55 is disposed rightward of the opening 21D, which is the rightmost one of the openings 21A to 21D, in this preferred embodiment. This eliminates the need to provide a space for the pivot 55 between two adjacent ones of the openings 21A to 21D, and thus reduces the distance between the two adjacent ones of the openings 21A to 21D. Consequently, the recording heads 30A to 30D are disposed close to each other, resulting in a size reduction of the inkjet head apparatus 1.

Although the adjusting screw 25 may be provided between two adjacent ones of the openings 21A to 21D, the adjusting screw 25 is disposed leftward of the opening 21A, which is the leftmost one of the openings 21A to 21D, in this preferred embodiment. In other words, the openings 21A to 21D are disposed between the pivot 55 and the adjusting screw 25 in the main scanning direction. This eliminates the need to provide a space for the adjusting screw 25 between two adjacent ones of the openings 21A to 21D, and thus reduces the distance between the two adjacent ones of the openings 21A to 21D. Consequently, the recording heads 30A to 30D are disposed close to each other, resulting in a size reduction of the inkjet head apparatus 1.

The inkjet head apparatus 1 according to this preferred embodiment includes the spring (i.e., the coil spring 19) to urge the head plate 20 so that the adjusting screw 25 constantly abuts against the abutment 15. This prevents the position of the head plate from being unintentionally changed during movement of the adjusting screw 25. Consequently, the positions of the recording heads 30A to 30D are adjusted reliably.

The inkjet head apparatus 1 according to this preferred embodiment includes the first shaft 17 provided on the abutment 15, and the second shaft 18 provided on the head plate 20. The spring preferably is the coil spring 19 attached to the first shaft 17 and the second shaft 18. Thus, the coil spring 19 is reliably disposed in a predetermined location. Consequently, the adjusting screw 25 stably abuts against the abutment 15.

In this preferred embodiment, the head plate 20 is fastened to the base plates 14L and 14R with the machine screws 50 inserted into the first to fourth holes 41 to 44. The first to fourth holes 41 to 44 are provided in the four corners of the head plate 20. More specifically, the first hole 41 is provided diagonally leftward and forward of the openings 21A to 21D, the second hole 42 is provided diagonally rightward and forward of the openings 21A to 21D, the third hole 43 is provided diagonally leftward and rearward of the openings 21A to 21D, and the fourth hole 44 is provided diagonally rightward and rearward of the openings 21A to 21D. This enables the head plate 20 to be stably fastened to the base plates 14L and 14R, and thus more reliably prevents displacement of the head plate 20 over time.

The above description of the preferred embodiments of the present invention is given by way of example only. The present invention may be embodied in various other forms.

In a preferred embodiment of the present invention, the pivot 55 is disposed rightward of the openings 21A to 21D, and the adjusting screw 25 is disposed leftward of the openings 21A to 21D. Alternatively, the locations of the pivot 55 and the adjusting screw 25 may be reversed. Specifically, the pivot 55 may be disposed leftward of the openings 21A to 21D, and the adjusting screw 25 may be disposed rightward of the openings 21A to 21D.

In a preferred embodiment of the present invention, an entirety of the pivot 55 and an entirety of the adjusting screw 25 are disposed rearward of the front ends of the openings 21A to 21D and forward of the rear ends of the openings 21A to 21D. Alternatively, a portion of the pivot 55 may be disposed rearward of the front ends of the openings 21A to 21D and forward of the rear ends of the openings 21A to 21D, and a portion of the adjusting screw 25 may be disposed rearward of the front ends of the openings 21A to 21D and forward of the rear ends of the openings 21A to 21D.

In a preferred embodiment of the present invention, the machine screws 50 are inserted into the first to fourth holes 41 to 44 so as to fasten the head plate 20 to the base plates 14L and 14R with the machine screws 50. Fasteners to fasten the head plate 20 to the base plates 14L and 14R are not limited to the machine screws 50. For example, any other suitable fasteners, such as screws, bolts, and/or pins, may be inserted into the first to fourth holes 41 to 44 so as to fasten the head plate 20 to the base plates 14L and 14R. The fasteners to fasten the head plate 20 to the left base plate 14L may be different from the fasteners to fasten the head plate 20 to the right base plate 14R.

In a preferred embodiment of the present invention, the adjusting screw 25 and the tapped hole 34 are structured such that clockwise rotation of the adjusting screw 25 causes the adjusting screw 25 to move in its direction of travel (i.e., rearward) and thus increases the amount of protrusion of the adjusting screw 25 from the tapped hole 34, and counterclockwise rotation of the adjusting screw 25 reduces the amount of protrusion of the adjusting screw 25 from the tapped hole 34. Alternatively, the adjusting screw 25 and the tapped hole 34 may be structured such that counterclockwise rotation of the adjusting screw 25 causes the adjusting screw 25 to move in its direction of travel (i.e., rearward) and thus increases the amount of protrusion of the adjusting screw 25 from the tapped hole 34, and clockwise rotation of the adjusting screw 25 reduces the amount of protrusion of the adjusting screw 25 from the tapped hole 34.

In a preferred embodiment of the present invention, the adjusting screw 25 is attached to the head plate 20, and the abutment 15 is fixed to the left base plate 14L. Alternatively, the adjusting screw 25 may be attached to the left base plate 14L, and the abutment 15 may be fixed to the head plate 20. The abutment 15 may be separate from or integral with the left base plate 14L or the head plate 20.

The recording heads 30A to 30D may eject ink of the same color or may eject inks of different colors.

Although the number of openings of the head plate 20 is preferably four, for example, in this preferred embodiment, the invention is not limited to any particular number of openings. The number of openings of the head plate 20 may be two, three, or five or more, for example. The number of recording heads may be changed in accordance with the number of openings of the head plate 20. In other words, the number of recording heads is not limited to four.

Preferred embodiments of the present invention includes any suitable combination of various elements and features of the preferred embodiments and variations thereof described above.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inkjet head apparatus comprising:
a carriage including side plates;
an inkjet head base plate provided with a plurality of openings at least some of which are located along a scanning direction, the inkjet head base plate being attached to the side plates at sides of the inkjet head base plate;
a plurality of inkjet heads each including a plurality of nozzles at least some of which are located along a sub-scanning direction, each of the inkjet heads being attached to the inkjet head base plate at one of the openings of the inkjet head base plate;
a pivot disposed between one of the side plates and the inkjet head base plate so that the inkjet head base plate is movably supported by the one of the side plates; and
an adjusting screw capable of adjusting a position of the inkjet head base plate with respect to the side plates by moving the inkjet head base plate about the pivot; wherein
at least a portion of the pivot and at least a portion of the adjusting screw are located between first and second longitudinal ends of the openings.

2. The inkjet head apparatus according to claim 1, wherein the at least some of the plurality of openings are aligned in a row perpendicular or substantially perpendicular to the sub-scanning direction.

3. The inkjet head apparatus according to claim 1, wherein the openings are disposed between the pivot and the adjusting screw in the scanning direction.

4. The inkjet head apparatus according to claim 1, further comprising:
an abutment disposed on one of the side plates and the inkjet head base plate;
a tapped hole which is disposed in another one of the side plates and the inkjet head base plate and into which the adjusting screw is disposed so that a portion of the adjusting screw protrudes from the tapped hole toward the abutment; and
a spring that urges the inkjet head base plate so that the adjusting screw abuts against the abutment.

5. The inkjet head apparatus according to claim 4, wherein
the abutment is disposed on one of the side plates and includes:
an abutment surface against which the adjusting screw abuts; and
a first shaft extending from a surface of the abutment opposite to the abutment surface; wherein
the tapped hole is disposed in a portion of the inkjet head base plate facing the abutment surface of the abutment;
the head plate includes a second shaft extending toward the first shaft from a portion of the inkjet head base plate facing the first shaft; and
the spring is a coil spring attached to the first shaft and the second shaft.

6. A printer comprising:
the inkjet head apparatus according to claim 1;
a rail supporting the inkjet head apparatus so that the inkjet head slides along the rail; and
a driver connected to the inkjet head apparatus and that causes the inkjet head apparatus to move along the rail.
